(19) United States
(12) Patent Application Publication
(10) Pub. No.: US 2013/0279605 A1
(43) Pub. Date: Oct. 24, 2013

(54) Perceptual Media Encoding

(71) Applicant: Scott A. Krig, Santa Clara, CA (US)

(72) Inventor: Scott A. Krig, Santa Clara, CA (US)

(21) Appl. No.: 13/993,806

(22) PCT Filed: Nov. 30, 2011
(86) PCT No.: PCT/US11/62600

§ 371 Date: Jun. 13, 2013

(51) Int. Cl. H04N 7/26

(52) U.S. Cl. CPC H04N 19/00545
USPC 375/240.26

(57) ABSTRACT

Conventional encoding formats that use I-frames, P-frames, and B-frames, for example, may be augmented with additional metadata that defines key colorimetric, lighting and audio information to enable a more accurate processing at render time and to achieve better media playback.

### BACKGROUND

This relates to encoding or compressing image data for computer systems.

In order to transfer extra data, the picture data is encoded in a format that takes up less bandwidth. Therefore, the media may be transferred more quickly.

Generally, a coder and/or decoder, sometimes called a CODEC handles the encoding of image frames and the subsequent decoding at their target destination. Typically, encoded image frames are encoded into I-frames, P-frames, and B-frames in accordance with widely used Motion Pictures Expert Group compression specifications. The main goal is to compress the media and only encode the parts of the media that change from frame to frame. Media is encoded and stored in files or sent across a network, and decoded for rendering at the display device.

### BRIEF DESCRIPTION OF THE DRAWINGS

FIG. 1 is a depiction of media frame types according to an indexed method using one embodiment of the present invention;

FIG. 2 is a depiction of encoded frames in accordance with an interleaved method of the present invention;

FIG. 3 is a flowchart for one embodiment of the present invention; and

FIG. 4 is a schematic depiction of one embodiment of the present invention.

### DETAILED DESCRIPTION

Conventional encoding formats that use I-frames, P-frames, and B-frames, for example, may be augmented with additional metadata that defines key colorimetric, lighting and audio information to enable a more accurate processing at render time and to achieve better media playback. Lighting and audio conditions where the media was created may be recorded and encoded with the media stream. Those conditions may be subsequently compensated for when rendering the media. In addition, characteristics of the image and audio sensor data may be encoded and passed to the rendering device to enable more accurate rendering of video and audio.

In one embodiment, the additional metadata may also be stored in a separate file such as an American Standard Code for Information Interchange (ASCII) file, Extensible Marking Language (XML) file, or the additional metadata may be sent or streamed over a communications channel or network along with the streamed media. Then the metadata may be used with the encoded media, after that media has been decoded.

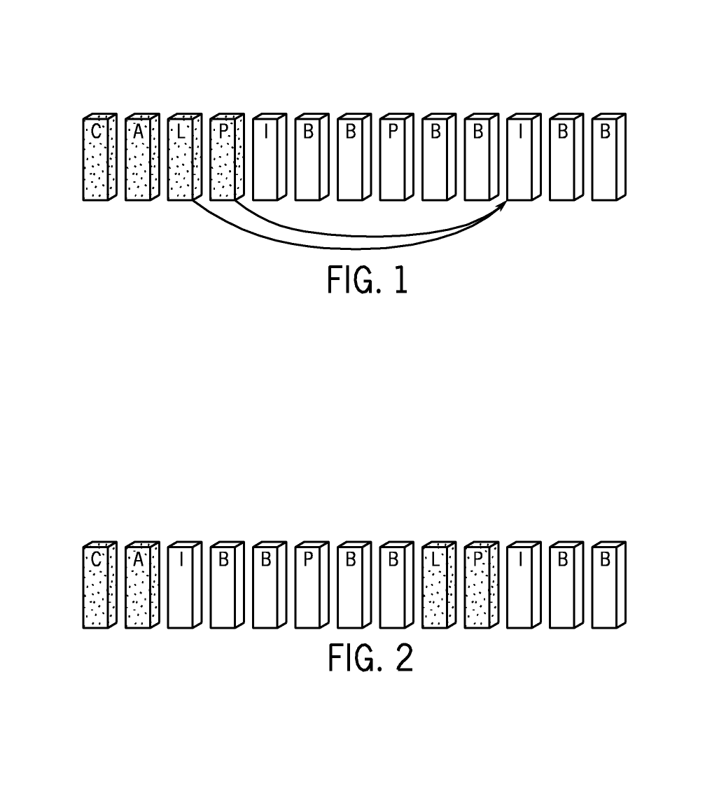

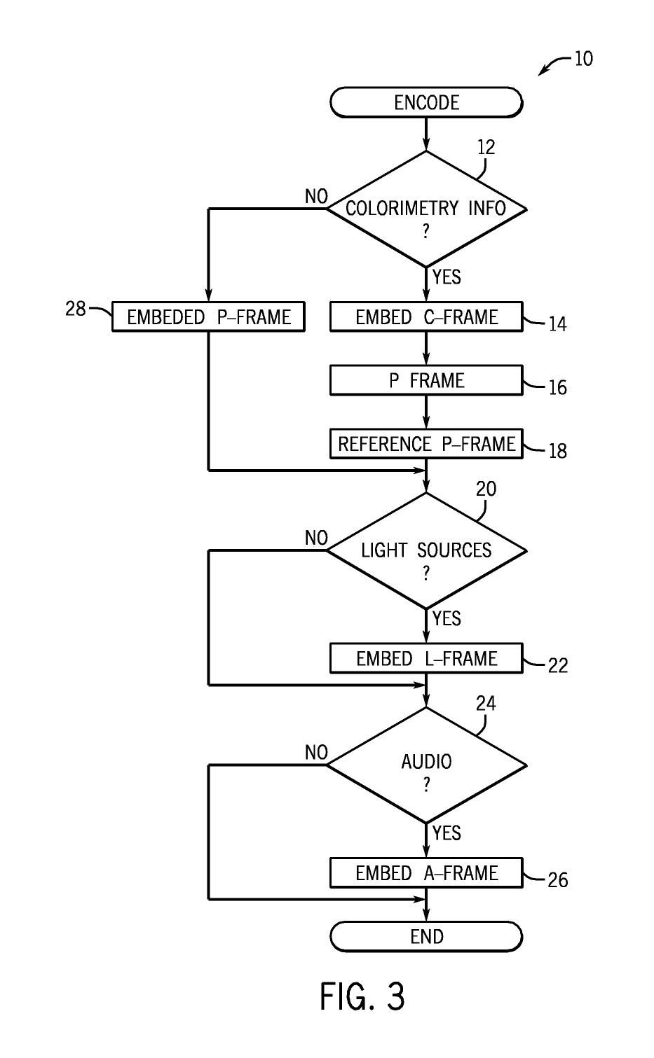

The additional frames that may be added are termed the C-frame, A-frame, L-frame, and P-frame here. These frames may be added in an indexed method shown in FIG. 1 or in an interleaved method shown in FIG. 2. In the interleaved method, the metadata frames are inserted into the media format. In the indexed method, the metadata frames are stored sequentially and point via an index into the coder decoder frames.

The indexed method may be stored in the same file or stream as the existing media or it may be stored into a separate file or stream that indexes into an existing media file or stream. The media may be transcoded or coded on the fly, and sent over a network rather than being stored into a file.

The metadata frames include colorimetric data in the C-frame, lighting data in the L-frame, audio data in the A-frame.

The C or colorimetric frame may include colorimetry information about input devices such as cameras and output devices for display. The input device information may be for the camera capture device. The colorimetric frame information may be used for gamut mapping from the capture device color space into the display device color space, enabling more accurate device modeling and color space transformations between the capture device and the rendering device for more optimal viewing experience, in some embodiments. The C-frames may provide colorimetrically accurate data to enable effective color gamut mapping at render time to achieve a better viewing experience in some embodiments.

When the colorimetry information changes at the capture device, a new C-frame can be added into the encoded video screen. For example, if a different camera and different scene lighting configuration is used, a new C-frame may be added into the encoded video screen to provide colorimetry details.

In one embodiment, the C-frames may be American Standard Code for Information Interchange (ASCII) text strings, Extensible Markup Language (XML) or any other binary numerical format.

The C-frame may include an identifier for the gamut information for reference in case another frame would like to refer to this frame and reuse its values. The colorimetry frame may also include input/output information indicating whether this C-frame is for an input device or output device. The frame may include model information identifying the particular camera or display device. It may include color gamut for a camera device in a chosen color space including minimum and maximum colorant values for selected colorants. The colorimetry information may further include scene conditions from the Color Appearance Modeling for Color Management Systems (CIECAM02) color appearance model provided by the CIE Technical Committee CIE TC8-01 (2004), Publication 159, Vienna CIE Central Bureau ISBN 3901906290. For example, other information that may be included include neutral access values for a gray access, black point values and white point values.

The P-frames may include video effects processing hints for various output rendering devices. The processing hints may enable the output device to render the media according to the best intentions from the media creator. The processing information may include gamut mapping methods, image processing methods such as convolution kernels, brightness, or contrast. The processing hints may be tied to specific display devices to enhance rendering characteristics for a particular display device.

The format of the P-strings may also be ASCII text streams, XML, or any binary format. The P-frame may include a reference number for the P-frame so that other frames can refer to this P-frame together with the output processing hints. They provide suggestions for gamut mapping methods and image plus processing methods for a list of known devices or default for an unknown display type. For example, for a particular television display, the P-frame may suggest post-processing for skin tones using a convolution filter in luminance space and providing the values. It may also suggest a gamut mapping method and perceptual rendering intent. Output device hints may also include a simple RGB or other color gamma function.

The P-frame may also include an output device gamut C-frame reference. A P-frame may reference by identifier, a C-frame within the encoded video stream to tailor processing for specific output device. The P-frame may include processing code hints. A customer algorithm supplied within the frame as a JAVA byte code or a Dx/G1 high level shader language (HLSL). The P-frame may be included in the preamble of the CODEC field in the P-frame or within the encoded stream in a P-frame and could be shared using a reference number.

The L-frame enables viewing time lighting adjustments and contains information about the known light sources for the scene as well as information about the ambient light at the scene. The light source information and scene information may be used by an intelligent display device that has sensors to find out about the light sources present in the viewing room as well as the ambient light present in the viewing room. For example, a display device may determine that the viewing room was dark and may attempt automatically to adjust for the amount of ambient light encoded in the media to optimize the viewing experience. Also, the intelligent viewing device may identify objectionable light sources in the viewing room and attempt to adjust the lighting in the rendering for the video display to adapt to objectionable, local lighting.

The L-frame may include a specular light vector which gives x, y, z vector information and shininess in terms of the percent of frame affected about a circular shape to enable detection of the position and direction of the light source and shininess intensity across the surface. The L-frame may also include the secular light color, which is colorimetry information describing the color temperature of the light source. The L-frame may include an ambient light color value which is colorimetry information describing color temperature of light source coming from all sides. The L-frame may include a diffuse light vector which is an x, y, z vector information to enable the determination of the position and direction of a light source. The L-frame may include a diffuse light color value which is colorimetry information describing color temperature of the light source. Finally, the L-frame may include a CIECAM02 information value for color appearance modeling.

The A-frames, for audio information, include information about the acoustics of the scene or the audio as captured as well as hints on how to perform audio processing at render time. The A-frame may include an audio microphone profile of the audio response of the capturing microphone or if multiple microphones are used for each of those microphones. The data format may be a set of spline points that generate a curve or a numeric array, for example, between zero and twenty-five kiloHertz.

Another value in the A-frame may be audio surround reverb which is a profile of the reverb response of the surrounding area where the recording was made. This may be useful to duplicate the reverb surroundings in the viewing room with an intelligent rendering device that can measure the reverb present in the viewing room to compensate audio rendering by running the audio through a suitable reverb device model.

The A-frame may include audio effect including a list of known audio plugins to recommend based on the model number of the display device in the room's surroundings. An example may be any Pro Tools digital audio work station (available from Avid Technology, Burlington, Mass.) digital effects and settings.

Finally the A-frame may include audio hints that are based on the knowledge of the rendering device of the audio system and may be used to adjust the equalizer and/or volume and/or stereo balance and/or surround effects of the audio, based on the characteristics of the audio rendering device. A list of common scene audio-influencing elements from the recording equipment may be inserted into the audio hints such as foggy because it damps sound, open area, hardwood floor, high ceiling, carpet, no windows, little or much furniture, big room, small room, a low or high humidity, air temperature, quiet, etc. The format may be a text string.

A sequence 10 may be used by a computer processor to produce the encoded C, A, L and P frames. The sequence may be implemented in hardware, software, and/or firmware. In software and hardware embodiments it may be implemented computer executed instructions stored in a non-transitory, readable medium such as an optical, magnetic or semiconductor memory.

The sequence 10 may begin by checking for colorimetry information at diamond 12. If such information is available, it may be embedded in the C-frame as indicated in block 14. Then a P-frame may be generated as indicated in block 16 and may be referenced as indicated in block 18.

A check at diamond 20 determines whether there are light source information available, and if so, they may be embedded in the L-frame as indicated in block 22. Finally a check at diamond 24 determines whether there is audio information and if so it is encoded in an A-frame block 26 as indicated.

If there is no colorimetry information, then a P-frame may be embedded as indicated in block 28.

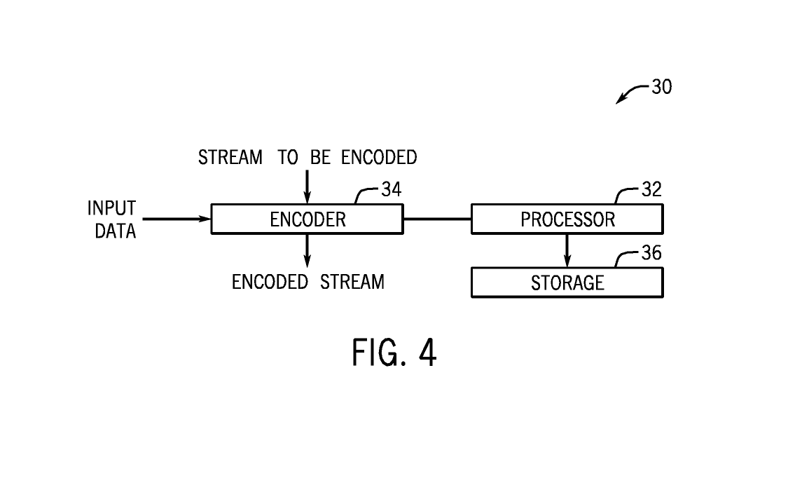

An encoder/decoder 30 architecture is shown in FIG. 4. The encoder 34 receives a stream to be encoded, input data for the C, L, A and P frames and outputs an encoded stream. An encoder 34 may be coupled to a processor 32 that executes instructions stored in the storage 36 including the sequence 10 in the software or firmware embodiment.

The graphics processing techniques described herein may be implemented in various hardware, software and firmware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
encoding a frame of image data; and
encoding at least one of colorimetric, lighting or audio metadata for said frame of image data.

2. The method of claim 1 including encoding colorimetric, lighting and audio metadata for said image data.

3. The method of claim 1, wherein encoding a frame includes encoding with I, P and B frames.

4. The method of claim 3 including storing the metadata sequentially with said I, P and B frames and using an index to point into said frames.

5. The method of claim 3 include interleaving metadata into said I, P and B frames.

6. The method of claim 1 including providing metadata about an imaging device used to capture said metadata.

7. The method of claim 1 including providing metadata about an output device used to display said image data.

8. The method of claim 1 including providing metadata about lighting sources at the location of image capture.

9. The method of claim 1 including encoding metadata for one or more specular light vector, a secular light color, an ambient light color, a diffuse light vector or a diffuse light color.

10. The method of claim 1 including providing metadata about the acoustics at an image capture site including a microphone profile or a reverb response profile or an equalizer profile or audio profile.

11. The method of claim 1, wherein providing colorimetric information includes providing an identifier for the colorimetry information, an identification of an input or output device, information about a color gamut or color device model for a camera, scene conditions, neutral axis value, black point value or white point value.

12. The method of claim 1 including providing video effects processing hints for output rendering devices.

13. The method of claim 1 including storing the metadata separated from the encoded frame.

14. The method of claim 1, including storing the metadata with the encoded frame.

15. A non-transitory computer readable medium storing instructions to cause a computer to:
encode a frame of image data; and
encode metadata about image capture conditions with the encoded frame.

16. The medium of claim 15 further storing instructions to encode metadata with I, P and B frames.

17. The medium of claim 16 further storing instructions to store the metadata sequentially with said I, P and B frames and use an index to point into said frames.

18. The medium of claim 16 further storing instructions to interleave metadata into said I, P and B frames.

19. The medium of claim 15 further storing instructions to provide metadata about an imaging device used to capture said metadata.

20. The medium of claim 15 further storing instructions to provide metadata about an output device used to display said image data.

21. The medium of claim 15 further storing instructions to store the metadata separated from the encoded frame.

22. The medium of claim 15 further storing instructions to store the metadata with the encoded frame.

23. An apparatus comprising:
an encoder to encode a frame of image data and to encode metadata about image capture conditions with the encoded frame; and
a storage coupled to said encoder.

24. The apparatus of claim 23 said encoder to encode metadata with I, P and B frames.

25. The apparatus of claim 16 said encoder to store the metadata sequentially with said I, P and B frames and use an index to point into said frames.

26. The apparatus of claim 16 said encoder to interleave metadata into said I, P and B frames.

27. The apparatus of claim 23 said encoder to provide metadata about an imaging device used to capture said metadata.

28. The apparatus of claim 23 said encoder to provide metadata about an output device used to display said image data.

29. The apparatus of claim 23 said encoder to store the metadata separated from the encoded frame.

30. The apparatus of claim 23 said encoder to store the metadata with the encoded frame.
